(19) United States
(12) Patent Application Publication
(10) Pub. No.: US 2019/0072440 A1
(43) Pub. Date: Mar. 7, 2019

(54) FIBRE-BASED SENSOR FOR YARN

(71) Applicant: Simon Fraser University, Burnaby (CA)

(72) Inventors: Carlo Menon, Coquitlam (CA); Andrea Ferrone, Coquitlam (CA)

(73) Assignee: Simon Fraser University, Burnaby (CA)

(21) Appl. No.: 16/118,211

(22) Filed: Aug. 30, 2018

Related U.S. Application Data
(60) Provisional application No. 62/552,410, filed on Aug. 31, 2017.

(51) Int. Cl. G01L 1/22; D02G 3/44; D02G 3/32; D03D 1/00; G06F 3/044

(52) U.S. Cl. CPC G01L 1/22; D02G 3/441; D02G 3/32; D10B 2401/18; G06F 3/044; D10B 2401/16; D03D 1/0088

(57) ABSTRACT

A fibre-based sensor for yarn senses strain or pressure and includes: (a) a fibre extending along a centerline with a first longitudinal portion thereof forming a first fibre member that is elastic and has a first stiffness, first hysteresis, and first electrical conductivity; and (b) a second fibre member selected as a second fibre or a second longitudinal portion of the fibre, the second fibre member being elastic, having a second stiffness, second hysteresis, and second conductivity, wherein the first and second fibre members are non-slidable relative to each other along the centerline, the first stiffness being greater than the second stiffness so sensor stiffness is dominated by the first stiffness, the first hysteresis being less than the second hysteresis so sensor hysteresis is dominated by the first hysteresis, the first conductivity being less than the second conductivity so sensor conductivity is dominated by the second electrical conductivity.

### CROSS-REFERENCE TO RELATED APPLICATIONS

This application claims priority of provisional application 62/552,410, filed 31 Aug. 2017, the entire contents of which are hereby incorporated by reference.

### BACKGROUND OF THE INVENTION

### 1. Field of Invention

This invention relates to mechanical sensors and, in particular, to a fibre-based sensor suitable for use in yarn that is operable to sense at least one of strain and pressure.

### 2. Description of Related Art

Strain, pressure and elongation forces can be sensed by transduction in which the quantity to be sensed is converted to an electrical signal. In response to deformation, movement, strain, pressure, force or a change thereof, transducers often exhibit a change in one or more of resistance, impedance, capacitance, and inductance. Electronic circuitry may be employed to sense a corresponding change in voltage, current or other electrical quantity. Electronics and other smart technologies may be employed to read the electrical quantity.

Some fibre-based sensors are suitable for use in yarn that can be sewn, stitched, knitted or otherwise fabricated into garments, blankets, sheets, antimacassars, carpets, mats or other textile products.

Textile products, such as garments, containing fibre-based sensors may be employed to monitor muscular action or other biomechanical movement, heart rate, breathing rate, other biological phenomena, etc.

Young's modulus of elasticity is a normalized measure of the stiffness of a solid material, and defines the relationship between stress and strain in a material. Dynamic modulus (sometimes complex modulus) is a property of viscoelastic materials defined by the ratio of stress to strain under vibratory conditions. The complex modulus consists of the storage modulus, which indicates the stored energy and represents the elastic aspect of the material, and the loss modulus, which indicates the energy dissipated as heat and represents the viscous aspect of the material.

Stiffness is shape-dependent. A filament structure having a radius of 2 millimetre (mm), a length of 5 mm, and a Young's modulus of 2 Giga-Pascals (GPa) has a calculated stiffness of 20.1 Mega-Newtons per metre (MN/m).

Deformable objects can exhibit mechanical elastic hysteresis. The hysteresis of a deformable object can be determined by applying to the object a cyclical mechanical force or pressure at a specifiable load frequency so as to produce strain in the object. Measuring stress associated with the object as a function of the produced strain permits the calculation of hysteresis expressed as a percentage.

United States patent application publication No. 2018/0195210 to Sunshine et al. discloses intertwined strands including non-conductive strands and insulated conductive strands with dielectric cores. Sunshine et al. disclose conductive strands that serve both a mechanical function of forming a part of a fabric and an electrical function of conveying signals, and that items made from the fabric can include pressure sensors and force sensors that are attached to the strands. However, the intertwined strands of Sunshine et al. themselves are not operable to sense strain or pressure.

United States patent application publication No. 2016/0282988 to Poupyrev et al. discloses a touch sensor for detecting touch-input. The touch sensor can be implemented by top and bottom textile layers having conductive threads woven therein so as to form a capacitive touch sensor. Poupyrev et al. disclose that when a user's finger touches the capacitive touch sensor, a controller detects the location and motion of the touch-input to detects gestures such as single-finger and multi-finger touches and swipes. However, the touch sensor of Poupyrev et al. does not provide a calibrated indication of strain or pressure.

United States patent application publication No. 2007/0042179 to Karayianni et al. discloses a composite yarn having an elastic textile fiber member and an electrically conductive planar filament surrounding the fiber member in a helical fashion. However, the conductive planar filament of Karayianni et al. is not disclosed as being non-slidable relative to the elastic textile fiber member and thus is not suitable for sensing strain or pressure on the elastic textile fiber member.

The literature discloses a rubber-based filament or yarn embedded with conductive particles or coated with a conductive coating. While introducing conductive particles or coatings can provide filaments and yarn with desirable electrical properties, the mechanical properties of such filaments and yarn suffer from the introduction of such conductive particles or coatings such that the rubber-based filaments and yarns are not compatible with industrial machines and finish processes common in the textile industries.

U.S. Pat. No. 7,750,790 to Yang et al. discloses a strain gauge that includes a fabric base and at least one conductive yarn. The conductive yarn is gimped with a non-conductive yarn and woven through a fabric in a sensing direction. Electrical power is applied to the conductive yarn for indicating an elongation of the strain gauge in response to external force in the sensing direction. However, the design of the strain gauge of Yang et al. is subject to improvement.

An object of the invention is to address the above shortcomings.

### SUMMARY

The above shortcomings may be addressed by providing, in accordance with one aspect of the invention, a sensor for sensing at least one of strain and pressure in response to at least one of a deformation force, a variation in humidity, a variation in temperature, a variation in a chemical composition of a fluid, and a variation in pressure, the sensor being elongated along a centerline, the sensor comprising: (a) a fibre extending along the centerline, the fibre comprising at least a first longitudinal portion thereof forming a first fibre member, the first fibre member being elastic along the centerline, the first fibre member having a first stiffness, a first hysteresis, and a first electrical conductivity; and (b) a second fibre member selected from the group consisting of a second fibre extending along the centerline and a second longitudinal portion of the fibre separate from the first longitudinal portion, the second fibre member being elastic along the centerline, the second fibre member having a second stiffness, a second hysteresis, and a second electrical conductivity, wherein the first and second fibre members are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity.

The second stiffness may be less than 20 Mega-Newtons per metre (MN/m). The second fibre member may have a modulus of elasticity of less than 2 Giga-Pascals (GPa). The second fibre member may have a storage modulus of less than 3 GPa when measured at room temperature by employing a load frequency of less than or equal to 1 GHz. The first fibre member may have a first elastic modulus and the second fibre member may have a second elastic modulus. The first elastic modulus may be greater than the second elastic modulus. The first elastic modulus may be at least two times greater than the second elastic modulus. The first fibre member may have a first elastic modulus and a first sectional area. The second fibre member may have a second elastic modulus and a second sectional area. The first elastic modulus may be less than the second elastic modulus and the first sectional area may be larger than the second sectional area. The first hysteresis may be equal to or less than 50% when tested at room temperature by employing a load frequency equal to or less than 0.1 Hz for a strain of the first fibre member that is equal to or less than 3%. The second hysteresis may be equal to or less than 50% when tested at room temperature by employing a load frequency equal to or less than 0.1 Hz for a strain of the second fibre member that is equal to or less than 3%. The sensor may have a sensor hysteresis that is equal to or less than 50% when tested at room temperature by employing a load frequency equal to or less than 0.1 Hz for a strain of the sensor that is equal to or less than 3%. The first hysteresis may be equal to or less than 25% when tested at room temperature by employing the load frequency equal to or less than 0.1 Hz for a strain of the first fibre member that is equal to or less than 1%. The second hysteresis may be equal to or less than 25% when tested at room temperature by employing the load frequency equal to or less than 0.1 Hz for a strain of the second fibre member that is equal to or less than 1%. The sensor hysteresis may be equal to or less than 25% when tested at room temperature by employing the load frequency equal to or less than 0.1 Hz for a strain of the sensor that is equal to or less than 1%. The second fibre member may be selected as the second longitudinal portion. The first and second longitudinal portions may be coaxial. The first fibre member may have a first friction coefficient and the second fibre member may have a second friction coefficient. The first friction coefficient may be less than the second friction coefficient. The first fibre member may be coaxially outward of the second fibre member such that the friction coefficient of the sensor is substantially determined by the first friction coefficient. The second fibre member may be coaxially outward of the first fibre member. The second fibre member may be formed as a coating on the fibre. The second fibre member may include a dopant. The second fibre member may contain more than 0.5% by weight of the dopant. The dopant may be electrically conductive. The second fibre member may contain more than 5% by weight of the dopant. The second fibre member may be selected as the second fibre. The sensor may further include an attachment member for attaching the first and second fibres to each other. The attachment member may be selected from the group consisting of a thread and a wire. The second fibre may be operable to be stretched along the centerline by at least 25% without breaking. The sensor may further include an electrical connection at the second fibre member for electrically connecting the second fibre member to electronic circuitry.

In accordance with another aspect of the invention, there is provided a sensor for sensing at least one of strain and pressure in response to at least one of a deformation force, a variation in humidity, a variation in temperature, a variation in a chemical composition of a fluid, and a variation in pressure, the sensor being elongated along a centerline, the sensor comprising: (a) first means for extending along the centerline, the first means comprising at least a first longitudinal portion thereof forming a first fibre member, the first fibre member being elastic along the centerline, the first fibre member having a first stiffness, a first hysteresis, and a first electrical conductivity; and (b) second means for extending along the centerline, the second means being selected from the group consisting of a second fibre extending along the centerline and a second longitudinal portion of the first means, the second longitudinal portion being separate from the first longitudinal portion, the second means being elastic along the centerline, the second means having a second stiffness, a second hysteresis, and a second electrical conductivity, wherein the first and second means are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity.

The sensor may further include attachment means for attaching the first and second means to each other.

In accordance with various aspects of the invention, a supporting material, when combined with a sensing element, may enhance at least one of the following properties: time response, hysteresis, creep, overshoot, and relaxation time. A Stretchable Yarn Composite Sensor (SYCS) may sense at least one of the following: stretching, compression, flexion, and twisting. The SYCS may be integrated in a textile and may sense at least one of its following state or variation of states: bending, stretching, compression, flexion, twisting, folding, wrinkles, temperature, pressure, and wetness. The supporting material may have hysteresis of less than 50% when a stretching or compressing cycle is applied at room temperature and at a load frequency equal to or less than 0.01 Hz for a strain of the supporting material that is equal to or less than 0.1%. The supporting material may have hysteresis of less than 25% when the stretching or compressing cycle is applied at room temperature and at the load frequency equal to or less than 0.01 Hz for a strain of the supporting material that is equal to or less than 0.05%. The supporting material may completely or partially cover the sensing material to decrease the friction coefficient when in contact with a third material. The sensing element may be able to convert by transduction at least a physical quantity selected from the group consisting of force, mass, length, elongation, pressure, strain, compression, torque, and frequency into an electrical quantity suitable for being read by an electronic device. The electrical quantity may be selected from the group consisting of voltage, resistance, current, capacitance, electrical charge, and induction. The sensing element may contain more than 0.5% in weight of conductive dopant. The sensing element may contain more than 5% in weight of conductive dopant. The sensing element may have an elongation at break greater than 25% at room temperature. The structural connection between the supporting material and the sensing material may be made by a hardware connection which connects the supporting material and the sensing material. The structural connection between the supporting material and the sensing material may be made by a hardware connection which bonds the supporting material and the sensing material. The hardware connection may be made by a synthetic or natural material. The hardware connection may be able to transfer at least one physical or mechanical property between the sensing element and the supporting material. The sensing material may have a stiffness lower than 20 MN/m. The sensing material may have a modulus of elasticity below 2 GPa. The sensing material may exhibit a storage modulus below 3 GPa when tested at a testing frequency of up to 1 Ghz. The modulus of elasticity of the supporting material may be higher than the elastic modulus of the sensing material. The sensing and supporting materials may be two or more distinct elements.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1a is a perspective view of a sensor for sensing at least one of strain and pressure according to a first embodiment of the invention;

FIG. 1b is a sectional front view of the sensor shown in FIG. 1a, showing a gap between a sensing element and a supporting material spanned by a hardware connection;

FIG. 2a is a perspective of the sensor for sensing at least one of strain and pressure according to a second embodiment of the invention;

FIG. 2b is a sectional front view of the sensor shown in FIG. 2a, showing an infinitesimally short segment of the sensor;

FIG. 2c is a sectional front view of the infinitesimally short segment of the sensor shown in FIG. 2b, showing the addition of a hardware connection;

FIG. 2d is a sectional front view of the sensor for sensing at least one of strain and pressure according to a third embodiment of the invention;

FIG. 3a is a side view of the sensor for sensing at least one of strain and pressure according to a fourth embodiment of the invention, showing the sensing element and the supporting material being coaxial to each other;

FIG. 3b is a side view of the sensor shown in FIG. 3a, showing the addition of a coaxial hardware connection disposed between the sensing element and the supporting material;

FIG. 3c is a side view of a yarn comprising the sensor of FIG. 3a collinear to the sensor of FIG. 3b;

FIG. 3d is a sectional front view of the sensor shown in FIG. 3a, showing the sensing element coaxially surrounded by the supporting material;

FIG. 3e is a sectional front view of the sensor shown in FIG. 3b, showing the sensing element coaxially surrounded by the hardware connection, which is coaxially surrounded by the supporting material;

FIG. 3f is a sectional front view of the sensor for sensing at least one of strain and pressure according to a fifth embodiment of the invention, showing the supporting material coaxially surrounded by the sensing element;

FIG. 3g is a sectional front view of the sensor shown in FIG. 3f, showing the addition of the coaxial hardware connection disposed between the supporting material and the sensing element;

FIG. 4a is a side view of the sensor for sensing at least one of strain and pressure according to a sixth embodiment of the invention, showing by dotted lines the sensing element stitched through the supporting material at spaced-apart stitch points of attachment;

FIG. 4b is a top view of the sensor shown in FIG. 4a, showing the sections of the sensing element that are exterior to the supporting material;

FIG. 4c is a side view of sensor shown in FIG. 4a, showing the addition of the hardware connection such that the sensing element, represented graphically by dotted lines, becomes embedded;

FIG. 4d is a side view of the sensor shown in FIG. 4c, showing the hardware connection completely surrounding the sensing element and the supporting material;

FIG. 5a is a side view of the sensor for sensing at least one of strain and pressure according to a seventh embodiment of the invention, showing the sensing element, supporting material, and hardware connection braided to form a yarn thread;

FIG. 5b is a front view of the sensor for sensing at least one of strain and pressure according to an eighth embodiment of the invention, showing a fabric formed by a knitting pattern in which parallel sensing element(s) and supporting material(s) are perpendicular to hardware connection(s); and

FIG. 5c is a schematic representation of the sensor for sensing at least one of strain and pressure according to an ninth embodiment of the invention, showing a fabric formed by a knitting pattern of intertwined loops of the sensing element, supporting material, and hardware connection.

### DETAILED DESCRIPTION

A sensor for sensing at least one of strain and pressure in response to at least one of a deformation force, a variation in humidity, a variation in temperature, a variation in a chemical composition of a fluid, and a variation in pressure, the sensor being elongated along a centerline, includes: (a) first means for extending along the centerline, the first means comprising at least a first longitudinal portion thereof forming a first fibre member, the first fibre member being elastic along the centerline, the first fibre member having a first stiffness, a first hysteresis, and a first electrical conductivity; and (b) second means for extending along the centerline, the second means being selected from the group consisting of a second fibre extending along the centerline and a second longitudinal portion of the first means, the second longitudinal portion being separate from said first longitudinal portion, the second means being elastic along the centerline, the second means having a second stiffness, a second hysteresis, and a second electrical conductivity, wherein the first and second means are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity. The sensor may further comprise attachment means for attaching the first and second means to each other.

Referring to the Figures, the sensor according to various embodiments of the invention is shown. The sensor is operable to act as a strain gauge, for example. More generally, the present invention relates to elastomeric material, fibre and yarn used in the construction of textile garments and more. For example, the present invention is related to various technologies using conductive material to monitor movements, elongation, strain, force compression and bending. The present invention provides an innovative way to enhance the performance of stretchable and flexible sensors for detecting and monitoring mechanical stress in fabric, cloth, textile, clothing and garments, for example.

The sensor shown in the Figures may be referred to as a Stretchable Yarn Composite Sensor (SYCS). The SYCS includes a fibre, which in some embodiments is fabricated by doping a substrate with a filler. The fibre may be referred to as a filament. Examples of substrates are: rubber, polymer and thermoplastics. Examples of fillers are: carbon black (CB), Carbon Nano tube (CNT), graphite, graphene, and gold, silver, iron and cupper particles.

The SYCS includes a first fibre member, such as the sensing element (SE) 20 shown in the Figures, which is able to sense strain or force, and a second fibre member, such as the supporting material (SM) 22. The SYCS, comprising the SE 20 and the SM 22, is able to detect stretch, stress, bending, compression, vibration, and twisting. The SE 20 can be based on rubber, polymer or a thermoplastic elastomer which is at least able to flex, stretch, or compress and is able to sense strain or force. The SM 22 is in contact with the SE 20 at one point at least, which in some embodiments results in transferring at least in part its mechanical and physical properties to the SE. In embodiments in which the SE 20 includes a doped compound, the dopant is distributed also inside its structure, which makes it reliable, robust and durable.

The SYCS in at least some embodiments is an elongated object defining a centerline extending along its length and passing centrally through each transverse cross-sectional area of the SYCS. The centerline dynamically conforms to the shape of the SYCS and to deformations thereof. The centerline is not necessarily a straight line. Unless otherwise stated, reference herein to extending along the centerline includes reference to extending so as to coincide with the centerline and also includes reference to extending adjacent to the centerline.

In variations of embodiments, either or both of the respective centerlines of the SE 20 and the SM 22 may coincide with the centerline of the SYCS, extend adjacent to the SYCS's centerline, extend parallel to the SYCS's centerline, spiral around the SYCS's centerline, weave closer to and farther from the SYCS's centerline, extend along in other patterned relationship(s) to the SYCS's centerline, or any combination thereof for example.

At least some embodiments of the present invention are operable to sense elongation and/or compression along the centerline of the SYCS. Additionally or alternatively, embodiments of the present invention may be operable to sense elongation and/or compression (e.g. squeezing) in one or more directions that are not parallel to the centerline, including in one or more radial directions perpendicular to the centerline. Some embodiments are operable to sense bending of the SYCS (e.g. curving and/or straightening of the centerline). Some embodiments are operable to sense torsion or twisting of the SYCS within any sectional plane including radially to the centerline. In general, the torsion or twisting may extend along any direction including being torsion or twisting extended along the centerline.

The SYCS is operable to enhance the performance of a sensing element (SE) 20 and reduce the undesired behaviour that usually affects the mechanical and physical property of sensing elements, such as rubber compounds. The implementation of the SYCS involves at least one SE 20 and at least one supporting material (SM) 22 that is at least able to flex, stretch or compress itself.

In at least some embodiments, the primary function of the SE 20 is to convert by transduction at least one physical quantity, such as force, elongation, pressure, strain, compression, torque, and/or moisture, into a quantity or signal of a different physical form, such as voltage, resistance, current, capacitance, frequency, and induction, that is easier to read with electronic or optoelectronic devices.

In at least some embodiments, the primary function of the SM 22 is to enhance the performance of the SE 20 by compensating for the shortcomings it might have, including poor elasticity, hardness, flexibility, stiffness, mechanical friction, hydrophobicity, heat resistance, magnetic and electrical reflection or absorption. For example, the SM 22 in some embodiments is operable to improve and enhance the performance and some physical properties of the sensing element, such as elasticity modulus, hardness, flexibility, stiffness, hydrophobicity, heat resistance, magnetic and electrical reflection or absorption.

Preferably, the SM 22 and the SE 20 are in contact at least at one point. A connection can be made by a hardware connection (HC) 24. Different synthetic and natural materials can be used to make the HC 24. In some embodiments, the SM 22 is implemented to be able to follow the movement and the behaviour of the SE 20. The HC 24 could be made in different ways; the HC 24 in some embodiments is able to facilitate the transfer of at least one physical or mechanical property between the SE 20 and the SM 22.

In some exemplary embodiments, the SE 20 is a thermoplastic elastomer strain gauge filament filled with conductive particles with modules of elasticity below 50 MPa and hysteresis of 6.5% at room temperature when a stretching or compressing cycle is provided, and the SM 22 is an elastic rubber band with modules of elasticity lower than 100 MPa. The sensor 20 and the SM 22 are connected together at least at one point. The connection can be made through a HC 24.

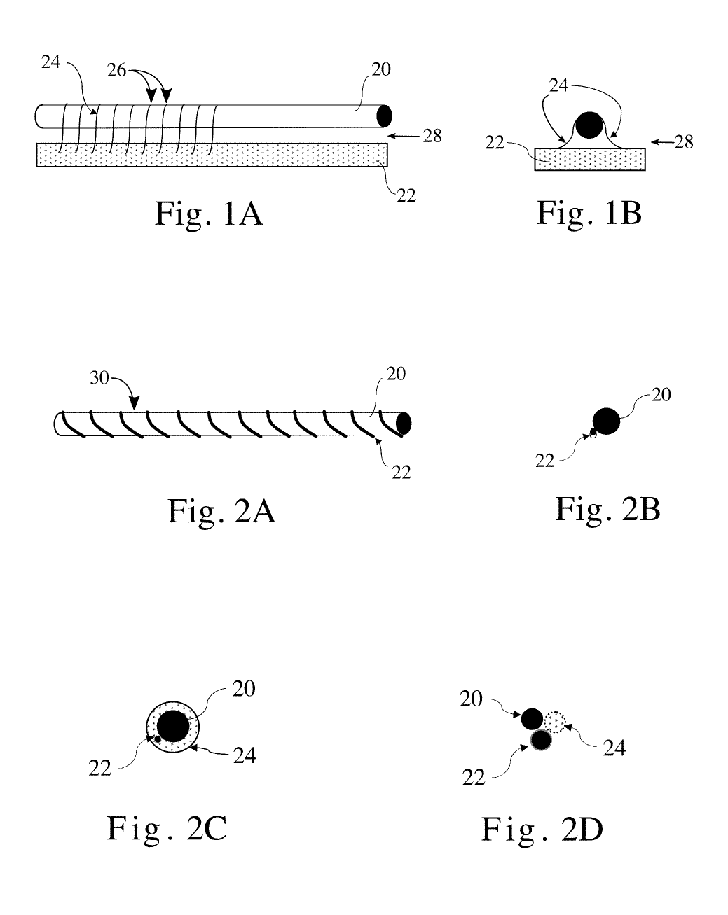

A yarn can be used to make the HC 24 that connects the SE 20 and the SM 22 by wrapping around them at fixed intervals 26. The gap 28 between the SE 20 and the SM 22 can vary and not compromise the functionality of the system. FIG. 1a and FIG. 1b (sectional view) show an example of a possible configuration.

In the exemplary embodiment of FIGS. 1a and 1 b, the SM 22 has a module of elasticity A greater than the module of elasticity of the SE 20, which we can represent with the letter B (i.e. A>B). In an assembled system, i.e. in the SYCS, the overall elasticity will be a weighted average of the SM 22 and the SE 20 during each deformation, thus reducing the hysteresis of the SYCS compared to that of the SE 20 alone.

The SE 20, which converts by transduction the physical deformation into an electrical parameter, is connected through a cable, wire or conductive material (e.g. threads, yarn, fabric, metallic insertions, etc.) to transfer its electrical measurements to an electronic board for reading, processing and transfer of the data.

The Figures illustrate different possible ways to implement the SYCS. Those skilled in the art will appreciate that the illustrations represent mere examples of the variety of configurations for the SYCS within the scope contemplated by the present invention.

FIGS. 1a and 1b illustrate one embodiment of the SYCS. The SYCS is operable to sense at least strain or pressure for detecting variations in deformation, force, humidity, temperature, pressure, or chemical composition of gas or liquid, and convert such strain or pressure by transduction into electrical signals. In at least one embodiment, the SYCS consists of the SE 20 and at least one SM 22. Preferably, the SM 22 is stiffer than the SE 20, the hysteresis of the SM 22 is less than that of the SE 20, and the SE 20 and the SM 22 are structurally connected to each other.

FIGS. 2a to 2c illustrate the SE 20 in contact with the SM 22 wrapped around the SE 20.

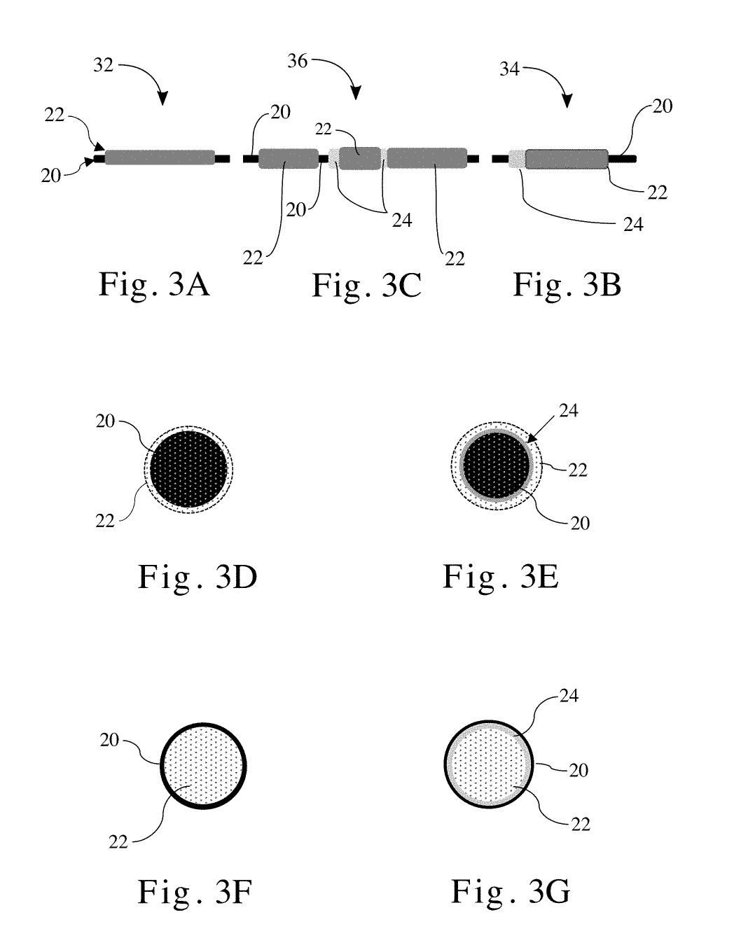

FIGS. 3a to 3g illustrate the structures of SE 20 and the SM 22 when coaxial, which may be referred to as being layered in a multi-core filament configuration. Different orders and at least one repetition pattern are shown in FIGS. 3a to 3g.

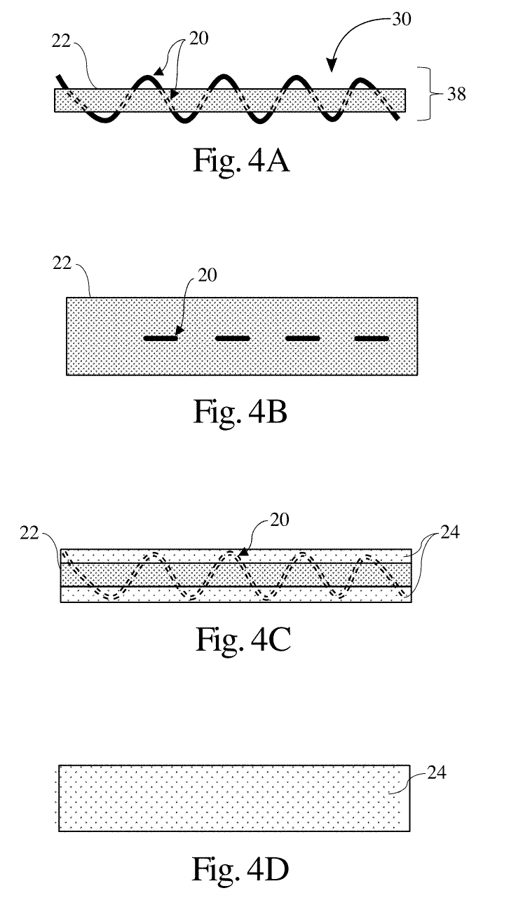

FIGS. 4a to 4d illustrate the structures of SE 20 and the SM 22 with a sewing pattern textile configuration. The sewn, knitted, or similar patterns of FIGS. 4a to 4d may be employed inside a garment, for example.

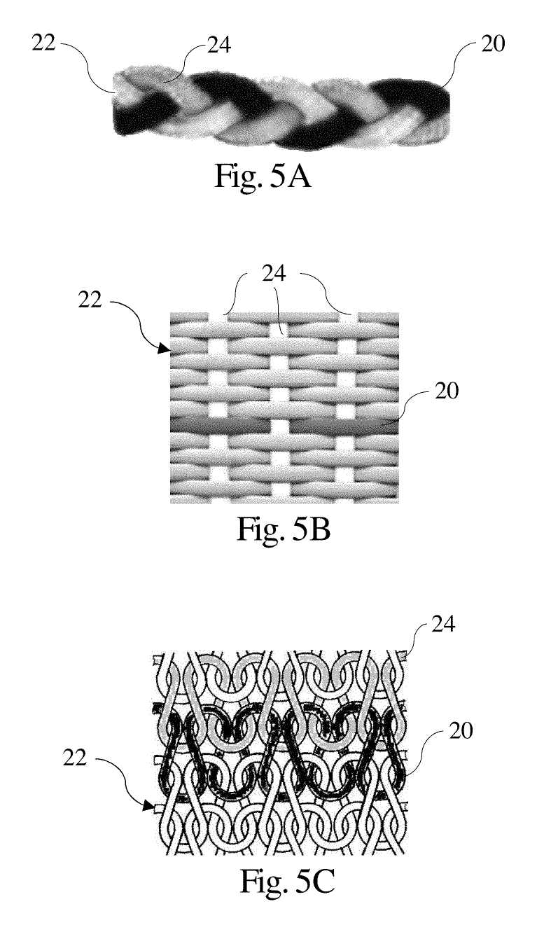

FIGS. 5a to 5c illustrate the structures of SE 20 and the SM 22 with other pattern textile configurations such as an embroidered pattern and a textile embedding pattern.

All of the configurations illustrated in the Figures can include the HC 24 as support.

Referring to the Figures, the SM 22 may be formed from commercial polyester yarns. In some embodiments, the SM 22 is operable to transfer tensile strain and mechanical properties to the SE 20. The SYCS is therefore suitable for being processed with industrial equipment. In fact, industrial machines for garment and textile production are generally designed to handle yarns such as cotton yarn that have a high tensile strain and low mechanical friction. The rubber-based yarn, such as may be employed to form the SE 20, is however usually characterized by high mechanical friction and low tensile strain and is therefore inherently not suitable to work well with industrial textile production machines. The configuration illustrated in FIGS. 2a and 2b (sectional view), where at least one layer of SM 22 (e.g. yarn or filament) is wrapped around the elastomer SE 20. The SYCS as described and illustrated herein can be handled by standard industrial machines for garment and textile production because the the properties of the SM 22, which in some embodiments is a polyester yarn wrapped around the SE 20, dominates those of the SE 20, thus increasing the tensile strength and reducing the friction of the SYCS as compared to the SE 20 alone. The gap 30 between each loop wrapped around the SE 20 can vary to modulate the properties of the yarn (e.g. a small gap 30 allows the yarn composite sensor to have a mechanical friction closer to the value of the SM 22). The gap 30 associated with the supporting material 22 must be sufficiently large to allow the movement of the SE 20 and affect at least one physical or mechanical property.

FIG. 2c shows the configuration of FIG. 2b with the addition of the support of the HC 24 that is around the yarn structures comprising at least one SE 20 and at least one SM 22.

FIG. 2d shows alternative structures of the yarn composed of at least one of the filaments SE 20, SM 22, and HC 24 wrapped together. The number of wrapping in this yarn structure per cm can be modulated to change the properties of the structure.

FIGS. 3a to 3g show the SYCS in the coaxial form of a multicore filament configuration layered in different order and repetition. The order of layer can be different (e.g. compare FIGS. 3d to 3g). The SYCS can contain different collinear sections with repeated configurations of layers and/or differently layered configurations.

FIG. 3a shows the simple layered structure 32, which at least contains one SE 20 and the SM 22. FIG. 3d illustrates the structure 32 in sectional view, and FIG. 3f illustrates a coaxially opposing configuration in which the coaxial relationship between the SE 20 and the SM 22 is reversed. In embodiments in which the SE 20 and the SM 22 are integrally connected, yet distinct portions of the SYCS by virtue of the introduction of a dopant (e.g. into the SE 20) or other changes in material, the boundary between the SE 20 and the SM 22 may be gradual and not distinctly defined. Nonetheless, it will be apparent to a person of ordinary skill in the art that the SE 20 and SM 22 are distinct portions of the SYCS.

FIG. 3b shows the buffered layered structure 34, that has at least a hard connection 24 that can be between the SM 22 and the SE 20. FIG. 3e illustrates the structure 34 in sectional view, and FIG. 3g illustrates a coaxially opposing configuration in which the coaxial ordering of the SE 20, HC 24, and SM 22 is reversed. In embodiments in which the SE 20, HC 24, and the SM 22 are integrally connected to each other, yet distinct portions of the SYCS by virtue of the introduction of a dopant (e.g. into the SE 20) or other changes in material, the boundaries between the SE 20, the HC 24 and/or the SM 22 may be gradual and not distinctly defined. Nonetheless, it will be apparent to a person of ordinary skill in the art that the SE 20, HC 24, and SM 22 are distinct portions of the SYCS.

FIG. 3c shows the repartitioned layered structures 36, that at least contain inside the yarn structures one repetition of layered structures such as simple layered structure 32, buffered layered structure 34 or a mix of them.

FIGS. 4a and 4b show a sewing pattern configuration comprised of at least one stitch point of SE 20 and at least one SM 22. The gap 30 between each stitch point 30 and the width 38 of the stitch, can be adjusted—the gap 30 is preferably large enough to permit the SE 20 to stretch or bend or torque or move or fold.

FIGS. 4b and 4d show the sewing pattern of FIGS. 4a and 4b with the addition of the HC 24 that at least covers one side of the SM 22 and is at least in contact at one point with the SE 20.

FIG. 5a shows an alternative structure of SYCS made by at least of one SE 20, one SM 22 and one HC 24 braided together to make a yarn or other braided structure.

The configurations and structures described herein above can be used to fabricate garments, other textile products, cloth and clothing and can be part of a smart system able to sense stretching, deformation, vibration, movement, torque and bending. The SYCS can form the textile itself of a garment or could be a patch attached to a cloth or other fabric product.

As shown in FIG. 5b, a textile product can include a combination of at least one SE 20, one SM 22, and one HC 24. In some embodiments, the SYCS includes a plurality of SM 22.

FIG. 5c shows an example of a knitting pattern where at least one SE 20, one SM 22, and optionally one HC 24 are combined together to result in a knitting texture. In general, different textile techniques (e.g. sewing, weaving, knitting, looming, etc.) and patterns can be used in the configurations shown in the Figures.

In addition to garments, applications of the present invention include textile to caver chair, other textiles, chair covers, futons, beds, car seats, steering wheel covers, carpeting, (sensitive) flooring, smart gadgets, rehabilitation exoskeletons and braces, tier, functionalized auto body as well as in bands attached to the human body. When used in garments or in sensorized bands for attaching to the body, the present invention can be used in systems for monitoring biomechanics movements, muscle deformations, and other biosignals including heart and breathing rates.

With reference to the Figures, the SM 22 has associated with it a stiffness, the SE 20 has associated with it a stiffness, and the SYCS has associated with it an overall stiffness that is a combination of the stiffness of the SM 22 and the stiffness of the SE 20. Preferably, the stiffness of the SM 22 is greater than that of the SE 20, and the overall stiffness of the SYCS is increased compared to that of the SE 20 alone. In some embodiments, the overall stiffness of the SYCS is closer to that of the SM 22 than to that of the SE 20. In some embodiments, the stiffness of the SYCS is substantially dominated by that of the SM 22. In some embodiments, the value of the stiffness of the SYCS is substantially determined by the value of the stiffness of the SM 22. In some embodiments, the stiffness of the SYCS is substantially equal to that of the SM 22.

With reference to the Figures, the SM 22 has associated with it a hysteresis, the SE 20 has associated with it a hysteresis, and the SYCS has associated with it an overall stiffness that is a combination of the stiffness of the SM 22 and that of the SE 20. Preferably, the hysteresis of the SM 22 is less than that of the SE 20, and the overall hysteresis of the SYCS is reduced compared to that of the SE 20 alone. In some embodiments, the overall hysteresis of the SYCS is closer to that of the SM 22 than to that of the SE 20. In some embodiments, the hysteresis of the SYCS is substantially dominated by that of the SM 22. In some embodiments, the value of the hysteresis of the SYCS is substantially determined by the value of the hysteresis of the SM 22. In some embodiments, the hysteresis of the SYCS is substantially equal to that of the SM 22.

With reference to the Figures, the SE 20 has associated with it an electrical conductivity, the SM 22 has associated with it an electrical conductivity, and the SYCS has associated with it an overall conductivity that is a combination of the conductivity of the SE 20 and the conductivity of the SM 22. Preferably, the conductivity of the SE 20 is greater than that of the SM 22, and the overall conductivity of the SYCS is increased compared to that of the SM 22 alone. In some embodiments, the overall conductivity of the SYCS is closer to that of the SE 20 than to that of the SM 22. In some embodiments, the conductivity of the SYCS is substantially dominated by that of the SE 20. In some embodiments, the value of the conductivity of the SYCS is substantially determined by the value of the conductivity of the SE 20. In some embodiments, the conductivity of the SYCS is substantially equal to that of the SE 20.

### Materials

With reference to the Figures, the material of the SE 20, the SM 22, and/or the HC 24 in various embodiments includes one or more materials in the elastomer material family of natural or synthetic rubbers, such as Polyurea, polyether-polyurea copolymer (e.g. Spandex, Lycra, Elastane), Natural polyisoprene, Synthetic polyisoprene, Polybutadiene (BR), Chloroprene rubber (CR) (e.g. Neoprene), Styrene-butadiene Rubber (SBR), Nitrile rubber, Hydrogenated Nitrile Rubbers (HNBR), Polyether block amides (PEBA), Perfluoroelastomers (FFKM), Fluoroelastomers (FKM), Fluorosilicone Rubber (FVMQ), Silicone rubber (SI, Q, VMQ), Polyacrylic rubber (ACM, ABR), Epichlorohydrin rubber (ECO), ethylene propylene rubber (EPM), Latex, Caoutchouc, and so on.

In various embodiments, the material of the SE 20, the SM 22, and/or the HC 24 includes one or more materials in the thermoplastic elastomer (TPE) material family, such as Thermoplastic polyurethane (TPU), Thermoplastic co-polyester (TPC, TPE-E), TPC-ET Thermoplastic co-polyester (e.g. Hytrel, KOPEL, etc.), Thermoplastic Elastomers on an olefin base (TPO, TPE-O), Styrenic block copolymers, TPS (TPE-s) Thermoplastic Vulcanizates (TPV, TPE-v), Thermoplastic polyamides (TPA, TPE-A), and so on.

In various embodiments, the material of the SE 20, the SM 22, and/or the HC 24 includes one or more materials in the styrenic block copolymer (SBC) family, such as Kraton, Poly(styrene-butadiene-styrene) SBS, Poly (butadiene-styrene-butadiene-) BSB, Styrene Ethylene Butylene Styrene Block Copolymer (SEBS) and so on.

In various embodiments, the material of the SE 20, the SM 22, and/or the HC 24 includes one or more materials in the fluoropolymer family, such as Polytetrafluoroethylene (PTFE), polyvinylfluoride (PVF), polytetrafluoroethylene (PTFE), polyvinylidene fluoride (PVDF), (polyethylenetetrafluoroethylene), fluorinated ethylene-propylene (FEP), Fluorocarbon [Chlorotrifluoroethylenevinylidene fluoride] (FPM/FKM), Perfluorosulfonic acid (PFSA) and so on.

In various embodiments, the material of the SE 20, the SM 22, and/or the HC 24 includes one or more materials in the Polysiloxanes (Silicone) family, such as Polydimethylsiloxane (PDMS), Poly (ethylene oxide) (PEO) and so on.

In various embodiments, the material of the SE 20, the SM 22, and/or the HC 24 includes one or more materials in the Polyamides (PA) (also known as polypeptides or proteins) family, such as wool, silk, nylons, aramids, sodium poly (aspartate), Aliphatic polyamides (Nylon, Nylon PA 6, PA 66, and so on), Polyphthalamides (PA 6T), aromatic polyamides (Paraphenylenediamine+terephthalic acid, Kevlar and Nomex) and so on.

In various embodiments, the material of the SE 20, the SM 22, and/or the HC 24 includes one or more of Polymide (PI), Kapton (trademark), Polysulfide, Halocarbon compounds, and so on.

In various embodiments, the material of the SE 20, the SM 22, and/or the HC 24 includes one or more of a conductive dopant, particle or ink, such as carbon nanotubes (CNTs), Carbon nano-wall (CNW), Single-Walled Carbon Nano tube (SW-CNT), carbon black, graphite, graphene nano-sheets, amorphous carbon, doped polyaniline, doped polypyrrole, poly(3,4-ethylenedioxythiophene) polystyrene sulfonate (PEDOT:PSS), metal particles, powders and/or dispersions (e.g. copper, silver, gold, etc.), mixtures thereof and so on.

With reference to the Figures, the SM 22 in some embodiments includes a plasticizer. In some embodiments, the SM 22 includes a cross-linked solution. In some embodiments, the SM 22 includes an antiplasticizer to modulate the plasticity and/or the viscosity of the SM 22 material.

In some embodiments, the SM 22 includes a Sylgard (trademark) material supplied by The Dow Chemical Company or a subsidiary thereof.

In various embodiments, the material of SM 22 includes one or more of Polyethylene (PE), Polybutylene (PBT), Polypropylene (PP), Polystyrene (PS), Acrylonitrile butadiene styrene (ABS), Polylactide (PLA), Polyvinyl chloride (PVC), Polyethylene terephthalate (PET), and/or fiberglass or natural and synthetic yarn structures such as cotton yarn, silk yarn, wool, canapa and so on.

With reference to the Figures, the material of the HC 24 in various embodiments includes one or more materials in the epoxy family, such as Epoxy resin, polyepoxides, Silpoxy, acrylic glass, Poly (methyl methacrylate) PMMA and so on.

In various embodiments, the material of the HC 24 includes one or more materials in the adhesive family, contact adhesives; hot-melt adhesives such as Ethylene-vinyl acetate (EVA), Low-density polyethylene (LDPE), High-density polyethylene (HDPE) or polyethylene high-density (PEHD), Polybutene-1, Amorphous polyolefin (APO/APAO) and so on; multi-component adhesives (e.g. Polyester resin—polyurethane resin, Polyols—polyurethane resin, Acrylic polymers—polyurethane resins, etc.); one-part adhesives that harden via a chemical reaction with an external energy source (e.g. radiation, heat, moisture, etc.), and so on.

In various embodiments, the material of the HC 24 includes one or more materials in the natural resin family, such as the copals, dammars, mastic, and sandarac, oleo-resins (frankincense, elemi, turpentine, copaiba), gum resins (ammoniacum, asafoetida, gamboge, myrrh, and scammony), and so on.

In various embodiments, the material of the HC 24 is combined with one or more crosslinking reagents. The crosslinking reagents may contain reactive ends to specific functional groups that link one polymer chain to another. For example, there may be employed primary amines and sulfhydryls, proteins or other molecules (Carboxyls (—COOH), Primary amines (—NH2) Sulfhydryls (—SH) Carbonyls (—CHO)), Photo-reactive crosslinkers (diazirines and aryl-azides etc.) and so on.

In various embodiments, the material of the SE 20, the SM 22, and/or the HC 24 includes or is combined with a solvent. The solvent may be operable to dissolve various materials associated with the SE 20, the SM 22 and/or the HC 24. The solvent(s) may be selected as one or more of Acetone, Isopropanol, Ethylene, methyl acetate, ethyl acetate, hexane, petrol ether, ethanol, toluene, turpentine, tetrachloroethylene, trichloroethylene (TCE), Dichloromethane (DCM), butanol, xylene, alcohol, ethyl cellosolve, cyclohexanone, mineral spirits, Methyl Ethyl Ketone (MEK), Dimethylformamide (DMF), Tetrahydrofuran (THF), and so on.

### Further Exemplary Embodiments

With reference to the Figures, including particularly FIG. 3f, the SYCS in some embodiments includes the SM 22 made of TPC-ET and having a diameter in the range of 50 micrometer (μm) to 1 millimetre (mm) that is surrounded by the SE 20 made of the TPC-ET forming a compound with at least 5% by weight of conductive filler (e.g. graphene) and having an annular thickness in the range of 1 μm to 500 μm. The total diameter of the SYCS can be varied for different applications, such as being in the range of 6 μm to 1.5 mm. The SYCS may have any desired length.

In some embodiments, the SYCS includes the SM 22 made of PEBA and having a diameter in the range of 50 μm to 1 mm that is surrounded by the SE 20 made of a SEBS-based compound with at least 10% by weight of conductive filler (e.g. graphene) and having an annular thickness in the range of 30 μm to 500 μm. The total diameter of the SYCS can be varied for different applications, such as being in the range of 80 μm to 1.5 mm. The SYCS may have any desired length.

With reference to the Figures, including particularly FIG. 3g, the SYCS in some embodiments includes the SM 22 made of TPC-ET and having a diameter in the range of 50 μm to 1 mm that is surrounded by the HC 24 made of a combination of TPC-ET and DCM which has an annular thickness in the range of 30 μm to 200 μm, which in turn is surrounded by the SE 20 made of the TPC-ET forming a compound with at least 10% by weight of conductive filler (e.g. graphene) and having an annular thickness in the range of 30 μm to 500 μm. The total diameter of the SYCS can be varied for different applications, such as being in the range of 110 μm to 1.7 mm. The SYCS may have any desired length.

In some embodiments, the SYCS includes the SM 22 made of TPC-ET and having a diameter in the range of 50 μm to 1 mm that is surrounded by the HC 24 made of a combination of TPC-ET and TCE which has an annular thickness in the range of 30 μm to 200 μm, which in turn is surrounded by the SE 20 made of the TPC-ET forming a compound with at least 10% by weight of conductive filler (e.g. graphene) and having an annular thickness in the range of 30 μm to 500 μm. The total diameter of the SYCS can be varied for different applications, such as being in the range of 110 μm to 1.7 mm. The SYCS may have any desired length.

In some embodiments, the SYCS includes the SM 22 made of PEBA and having a diameter in the range of 50 μm to 1 mm that is surrounded by the HC 24 made of a combination of TPC-ET and TCE which has an annular thickness in the range of 30 μm to 200 μm, which in turn is surrounded by the SE 20 made of the TPC-ET forming a compound with at least 5% by weight of conductive filler (e.g. carbon nanotube) and having an annular thickness in the range of 30 μm to 500 μm. The total diameter of the SYCS can be varied for different applications, such as being in the range of 110 μm to 1.7 mm. The SYCS may have any desired length.

In some embodiments, the SYCS includes the SM 22 made of PEBA and having a diameter in the range of 50 μm to 1 mm that is surrounded by the HC 24 made of Silpoxy and having an annular thickness in the range of 30 μm to 200 μm, which in turn is surrounded by the SE 20 made of a SEBS-based compound with at least 15% by weight of conductive filler (e.g. carbon black) and having an annular thickness in the range of 30 μm to 500 μm. The total diameter of the SYCS can be varied for different applications, such as being in the range of 110 μm to 1.7 mm. The SYCS may have any desired length.

### Exemplary Fabrication Processes

In variations of embodiments, the SYCS can be fabricated by one or more of the following processes: extrusion, molding, melt-spinning, dip coating, low energy ion implantation, printing, spraying, laminating, thermoforming moulding (e.g. compression, transfer, Injection, blow, rotational), calendering, spinning (e.g. wet, dry, dry jet-wet, melt, gel, and electrospinning), gravure printing, sewing, weaving, knitting, looming, yarn spinning, yarn ring spinning, yarn braiding, and so on.

With reference to the Figures, including particularly FIG. 3g, the SYCS in some embodiments is fabricated by tri-layer coaxial extrusion such that the SYCS includes the SM 22 formed as a core surrounded by the HC 24, which in turn is surrounded by the SE 20.

With reference to the Figures, including particularly FIG. 3f, the SM 22 in some embodiments is fabricated by a single extrusion to form a core, and thereafter the SE 20 is fabricated by dip coating.

With reference to the Figures, including particularly FIG. 3f, the SM 22 in some embodiments is fabricated by a single extrusion to form a core, and thereafter the SE 20 is fabricated by at least spray coating.

With reference to the Figures, including particularly FIG. 3g, the SM 22 in some embodiments is fabricated by spinning, the HC 24 is fabricated by at least spray coating, and the SE 20 is fabricated by dip coating.

With reference to the Figures, including particularly FIG. 3g, the SM 22 in some embodiments is fabricated by calendaring, the HC 24 is fabricated by dip coating, and the SE 20 is fabricated by at least spray coating.

With reference to the Figures, including particularly FIGS. 4a to 4d, the SM 22 in some embodiments is fabricated by moulding, the SE 20 is fabricated by extrusion and then sewn into the SM 22, and the HC 24 is fabricated by at least spray coating.

With reference to the Figures, including particularly FIGS. 4a to 4d, the SM 22 in some embodiments is fabricated by extrusion, the SE 20 is also fabricated by extrusion, and then the separate fibres or filaments SM 22 and SE 20 are combined through a yarn spinning process. Thereafter, the HC 24 is fabricated by spray coating and/or dip coating.

### Hysteresis Measurement

The SYCS according to embodiments of the present invention preferably has a hysteresis of less than 50%, when the SYCS under test is a filament or fibre having a length of 10 centimetres (cm), a diameter of 0.4 mm, and when the SYCS under test is subjected to a stroke of 1 cm and a velocity of 5 mm/s so as to result in a stress-relax cycle frequency of 0.25 Hz.

Thus, there is provided a sensor for sensing at least one of strain and pressure in response to at least one of a deformation force, a variation in humidity, a variation in temperature, a variation in a chemical composition of a fluid, and a variation in pressure, the sensor being elongated along a centerline, the sensor comprising: (a) a fibre extending along the centerline, the fibre comprising at least a first longitudinal portion thereof forming a first fibre member, the first fibre member being elastic along the centerline, the first fibre member having a first stiffness, a first hysteresis, and a first electrical conductivity; and (b) a second fibre member selected from the group consisting of a second fibre extending along the centerline and a second longitudinal portion of the fibre separate from the first longitudinal portion, the second fibre member being elastic along the centerline, the second fibre member having a second stiffness, a second hysteresis, and a second electrical conductivity, wherein the first and second fibre members are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A sensor for sensing at least one of strain and pressure in response to at least one of a deformation force, a variation in humidity, a variation in temperature, a variation in a chemical composition of a fluid, and a variation in pressure, the sensor being elongated along a centerline, the sensor comprising:
(a) a fibre extending along the centerline, the fibre comprising at least a first longitudinal portion thereof forming a first fibre member, the first fibre member being elastic along the centerline, the first fibre member having a first stiffness, a first hysteresis, and a first electrical conductivity; and
(b) a second fibre member selected from the group consisting of a second fibre extending along the centerline and a second longitudinal portion of the fibre separate from said first longitudinal portion, the second fibre member being elastic along the centerline, the second fibre member having a second stiffness, a second hysteresis, and a second electrical conductivity,
wherein the first and second fibre members are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity.

2. The sensor of claim 1 wherein the second stiffness is less than 20 MN/m.

3. The sensor of claim 1 wherein the second fibre member has a modulus of elasticity of less than 2 GPa.

4. The sensor of claim 3 wherein the second fibre member has a storage modulus of less than 3 GPa when measured at room temperature by employing a load frequency of less than or equal to 1 GHz.

5. The sensor of claim 1 wherein the first fibre member has a first elastic modulus and the second fibre member has a second elastic modulus, the first elastic modulus being greater than the second elastic modulus.

6. The sensor of claim 5 wherein the first elastic modulus is at least two times greater than the second elastic modulus.

7. The sensor of claim 1 wherein the first fibre member has a first elastic modulus and a first sectional area, the second fibre member having a second elastic modulus and a second sectional area, the first elastic modulus being less than the second elastic modulus and the first sectional area being larger than the second sectional area.

8. The sensor of claim 1 wherein the sensor hysteresis is equal to or less than 50% when tested at room temperature by employing a load frequency equal to or less than 0.1 Hz for a strain of the sensor that is equal to or less than 3%.

9. The sensor of claim 1 wherein the sensor hysteresis is equal to or less than 25% when tested at room temperature by employing a load frequency equal to or less than 0.1 Hz for a strain of the sensor that is equal to or less than 1%.

10. The sensor of claim 1 wherein the second fibre member is selected as the second longitudinal portion, the first and second longitudinal portions being coaxial.

11. The sensor of claim 10 wherein the first fibre member has a first friction coefficient, the second fibre member has a second friction coefficient, the first friction coefficient is less than the second friction coefficient, and the first fibre member is coaxially outward of the second fibre member such that the friction coefficient of the sensor is substantially determined by the first friction coefficient.

12. The sensor of claim 10 wherein the second fibre member is coaxially outward of the first fibre member.

13. The sensor of claim 12 wherein the second fibre member is formed as a coating on the fibre.

14. The sensor of claim 12 wherein the second fibre member comprises a dopant, the second fibre member containing more than 0.5% by weight of the dopant, the dopant being electrically conductive.

15. The sensor of claim 14 wherein the second fibre member contains more than 5% by weight of the dopant.

16. The sensor of claim 1 wherein the second fibre member is selected as the second fibre, the sensor further comprising an attachment member for attaching the first and second fibres to each other.

17. The sensor of claim 16 wherein the attachment member is selected from the group consisting of a thread and a wire.

18. The sensor of claim 16 wherein the second fibre is operable to be stretched along the centerline by at least 25% without breaking.

19. The sensor of claim 1 further comprising an electrical connection at the second fibre member for electrically connecting the second fibre member to electronic circuitry.

20. A sensor for sensing at least one of strain and pressure in response to at least one of a deformation force, a variation in humidity, a variation in temperature, a variation in a chemical composition of a fluid, and a variation in pressure, the sensor being elongated along a centerline, the sensor comprising:
(a) first means for extending along the centerline, the first means comprising at least a first longitudinal portion thereof forming a first fibre member, the first fibre member being elastic along the centerline, the first fibre member having a first stiffness, a first hysteresis, and a first electrical conductivity; and
(b) second means for extending along the centerline, the second means being selected from the group consisting of a second fibre extending along the centerline and a second longitudinal portion of the first means, the second longitudinal portion being separate from said first longitudinal portion, the second means being elastic along the centerline, the second means having a second stiffness, a second hysteresis, and a second electrical conductivity,
wherein the first and second means are non-slidable relative to each other along the centerline, the first stiffness being greater than the second stiffness such that a sensor stiffness associated with the sensor is closer in value to the first stiffness than to the second stiffness, the first hysteresis being less than the second hysteresis such that the a sensor hysteresis associated with the sensor is closer in value to the first hysteresis than to the second hysteresis, the first electrical conductivity being less than the second electrical conductivity such that a sensor electrical conductivity associated with the sensor is closer in value to the second electrical conductivity than to the first electrical conductivity.

21. The sensor of claim 20 further comprising attachment means for attaching the first and second means to each other.
